(19) United States
(12) Patent Application Publication
(10) Pub. No.: US 2006/0143867 A1
(43) Pub. Date: Jul. 6, 2006

(54) Handle with a detachable wrist strap attachment

(75) Inventor: Ching-Hsiang Wu, Taichung Hsien (TW)

Correspondence Address: DELLETT & WALTERS, P. O. BOX 82788, PORTLAND, OR, 97282-0788, US

(73) Assignee: EVER BUILD-UP INDUSTRIES LTD.

(21) Appl. No.: 11/029,126

(22) Filed: Jan. 3, 2005

(51) Int. Cl. E05B 1/00

(52) U.S. Cl. 16/436

(57) ABSTRACT

A handle with a detachable wrist strap attachment has a body, a latch block and a wrist strap attachment. The body has a top cavity and a side channel extending upwardly to communicate with the top cavity. The latch block is pivotally mounted pivotally inside the top cavity and has an eccentrically curved toothed pawl face and a thumb tab connecting to the eccentrically curved toothed pawl face and protruding out of the top cavity. The wrist strap attachment has wrist clamp, a latch tab entering the top cavity through the side channel and a toothed face formed on the latch tab to engage the eccentrically curved toothed pawl face on the latch block. When the wrist strap attachment engages the latch block, the latch tab is pulled down and pivots the latch block that tightly wedges and securely holds the latch tab between the latch block and a side of the cavity.

### BACKGROUND OF THE INVENTION

1. Field of the Invention

The present invention relates to a handle, and more particularly to a handle with a detachable wrist strap attachment that is dismantled conveniently.

2. Description of Related Art

With reference to FIG. 7, a conventional handle with a detachable wrist strap attachment comprises a body (90), a latch (94) and a wrist strap attachment (80).

The body (90) is cylindrical and has an inclined top face (not numbered), a bottom end (not numbered), a side surface (not numbered), a cavity (91) and a channel (96). The cavity (91) is defined in the inclined top face and has an inner surface (not numbered) and two sides (not numbered). The channel (96) is defined in the side surface and communicates with one side of the cavity (91). The bottom end of the body (90) is attached to a shaft (50) for a hiking stick, a ski pole, a tool or the like.

The latch (94) is mounted inside the cavity (91) and is composed of a V-shaped spring (93), a stationary mounting block (944) and a movable latch block (942). The V-shaped spring (93) has a stationary end (not numbered) and a movable end (not numbered). The stationary mounting block (944) is attached to one end of the V-shaped spring (93) and the side of the cavity (91) that does not communicate with the channel (96). The movable latch block (942) is attached to the other end of the V-shaped spring (93) and has a toothed pawl face (not numbered) and an enlarged head (not numbered). The toothed pawl face faces the side of the cavity (91) that communicates with the channel (96). The enlarged head extends out of the cavity (91) to allow a person to push the latch (94) conveniently.

The wrist strap attachment (80) is attached securely to a wrist strap (82), is inserted into the cavity (91) via the channel (96) and is composed of a strap clamp (not numbered) and a latch tab (81). The strap clamp attaches the wrist strap attachment (80) to a wrist strap (82). The latch tab (81) is made of rigid material, is an elongated strip (not numbered) and has an inside end (not numbered), an outside end (not numbered), an inside surface (not numbered) and a toothed face (not numbered). The toothed face is formed on the inside surface near the inside end and corresponds to the toothed pawl face on the movable latch block (942). The latch tab (81) is attached to the body (90) by inserting the elongated strip into the channel (96) and the cavity (91) until the toothed face on the latch tab (81) engages the toothed pawl face on the movable end (942) of the latch (94). The V-shaped spring (93) provides a restitution force on the movable latch block (942) so the movable latch block (942) presses and engages the latch tab (81) to firmly attach the wrist strap attachment (80) to the body (90).

However, extended use of the V-shaped spring (93) eventually results in elastic fatigue that makes the V-shaped spring (93) lose its restitution force. When the restitution force reduces sufficiently, the wrist strap attachment (80) will disengage so easily from the latch (94) that a normal jolt or the slightest touch of the enlarged head will disengage the wrist strap attachment (80).

To overcome the shortcomings, the present invention provides an improved handle to obviate the aforementioned problems.

### SUMMARY OF THE INVENTION

The main objective of the invention is to provide a handle with a detachable wrist strap attachment that is firmly held in the handle without a force from a resilient element.

To achieve the foregoing main objective, the handle comprises a body, a latch block and a wrist strap attachment.

The body has a top cavity and a side channel extending upward and communicating with the top cavity.

The latch block is pivotally mounted inside the top cavity and has an eccentrically curved toothed pawl face and a thumb tab connecting to the curved toothed pawl face and protruding from the top cavity.

The wrist strap attachment has a strap clamp attached to a wrist strap, a latch tab passing through the side channel into the top cavity and a tooth face formed on the latch tab to engage the curved toothed pawl face on the latch block.

When the wrist strap attachment engages the latch block, the latch tab is pulled down and pivots the latch block that tightly wedges and securely holds the latch tab between the latch block and a side of the cavity with the arrangement of the eccentrically curved toothed pawl face.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of a handle with a detachable wrist strap attachment in accordance with the present invention with the handle mounted on a shaft;

FIG. 2 is an operational perspective view of the handle in FIG. 1;

FIG. 3 is a cross-sectional side view of the handle with a detachable wrist strap attachment in FIG. 1;

FIG. 4 is an operational cross-sectional side view of the handle with a detachable wrist strap attachment in FIG. 3 with the wrist strap attachment being released;

FIG. 5 is an exploded perspective view of another embodiment of the handle with a detachable wrist strap attachment in accordance with the present invention;

FIG. 6 is a cross-sectional side view of the handle in FIG. 5; and

FIG. 7 is a cross-sectional side view of a conventional handle with a detachable wrist strap attachment in accordance with the prior art.

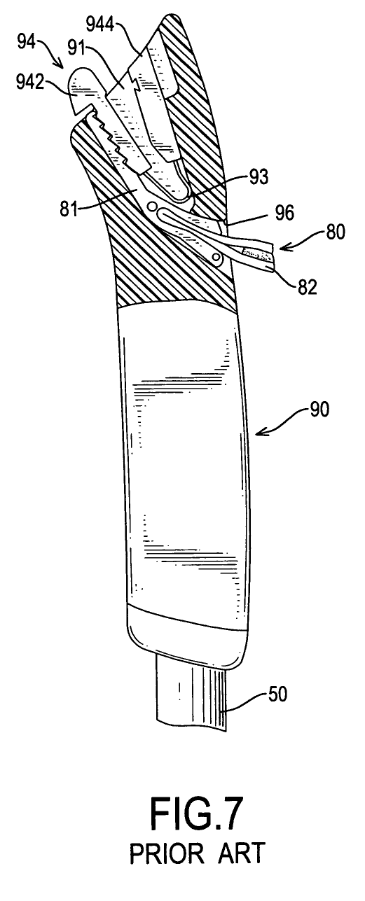

### DETAILED DESCRIPTION OF PREFERRED EMBODIMENT

A handle with a detachable wrist strap attachment in accordance with the present invention comprises a body, a latch block and a wrist strap attachment. The body has a top cavity and a side channel extending upward and communicating with the top cavity. The latch block is mounted pivotally inside the top cavity and has an eccentrically curved toothed pawl face and a thumb tab connecting to the eccentrically curved toothed pawl face and protruding out of the top cavity. The wrist strap attachment has a wrist clamp attached to a wrist strap and a latch tab extending through the side channel into the top cavity. The latch tab has a toothed face that engages the eccentrically curved toothed pawl face on the latch block. When the wrist strap attachment engages the latch block, the latch tab is pulled down and pivots the latch block that tightly wedges and securely holds the latch tab between the latch block and a side of the cavity.

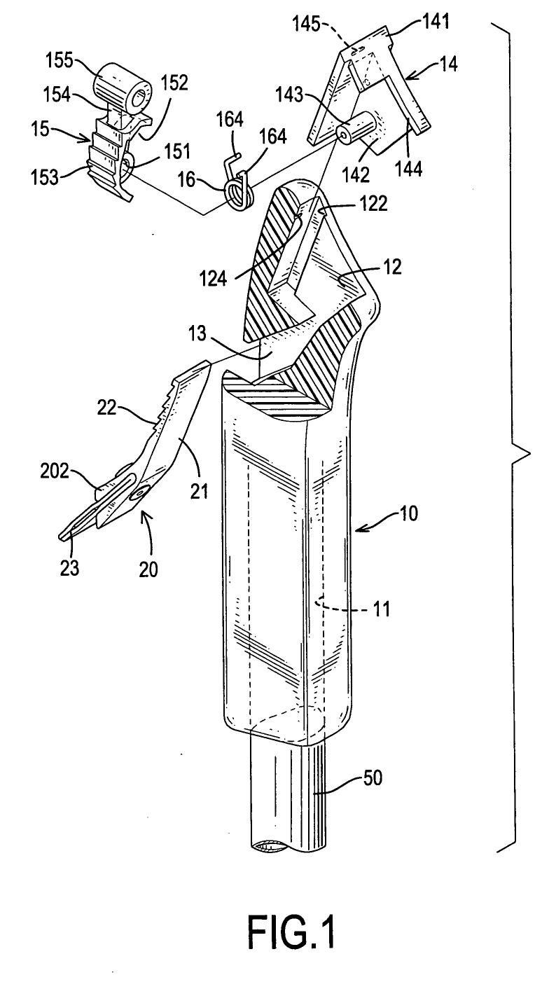

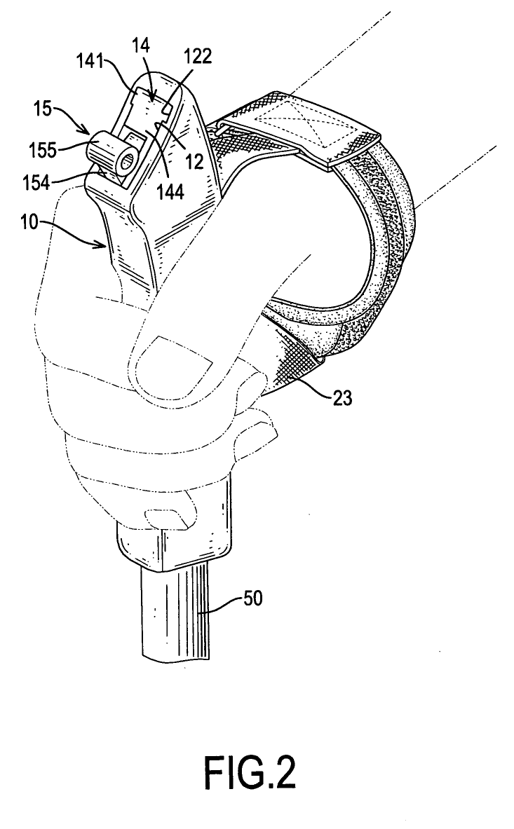

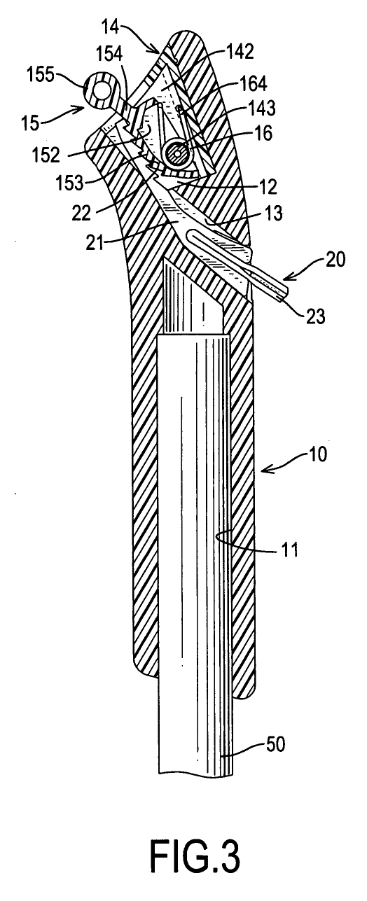

With reference to FIGS. 1 to 3, a preferred embodiment of a handle in accordance with the present invention comprises a body (10), a latch block (15), a wrist strap attachment (20), an optional mounting bracket (14) and an optional torsion spring (16).

The body (10) is an elongated solid and has a top end, a bottom end, an optional inclined top face, a side surface, an optional shaft recess (11), a cavity (12), and a channel (13).

The inclined top face is formed at the top end of the body (10). The shaft recess (11) is defined longitudinally at the bottom end of the body to mount a shaft (50) of a mountaineering stick, a walking stick, a ski pole, an ice ax, a tool or the like. The cavity (12) is defined in the inclined top face at the top end of the body (10), is optionally rectangular and has an open top, an upper side, a lower side, two sidewalls, a bottom, two optional grooves (122) and an optional detent (124). The two grooves (122) are defined respectively in the two sidewalls near the upper side of the cavity (12). The detent (124) is defined on the upper side of the cavity (12) near the open top. The channel (13) is defined in the body (10) through the side surface, extends upward and communicates with bottom of the cavity (12).

The mounting bracket (14) is mounted inside the cavity (12) of the body (10) and is composed of a rear wall, a top cover, a sidewall (142), a post (143) and an optional stub (145). The rear wall has two optional flanges (141) oppositely extending outward to respectively engage the two grooves (122) in the cavity (12). The top cover has a cutout (144). The sidewall (142) is mounted between the rear wall and the top cover. The post (143) is formed on the sidewall (142) to hold the latch block (15) in position. The stub (145) is formed on the upper wall to engage the detent (124) in the cavity (12) to hold the mounting bracket (14) in the cavity (12). When the mounting bracket (14) is mounted completely inside the cavity (12), the top cover closes the open top of the cavity (12).

The latch block (15) pivotally mounted on the mounting bracket (14) inside the cavity (12) and has a sidewall, an eccentrically curved flange, an inner space (152), a pivot sleeve (151), a neck (154) and a thumb tab (155). The sidewall is substantially oval and has a curved edge. The eccentrically curved flange is formed on and protrudes from the curved edge of the sidewall. The eccentrically curved flange has a top, an outer face and an eccentrically curved toothed pawl face (153). The eccentrically curved toothed pawl face (153) is formed on the outer face of the curved flange to selectively engage the wrist strap attachment (20). The inner space (152) is formed between the sidewall and the eccentrically curved flange. The pivot sleeve (151) is formed on the sidewall, protrudes into the inner space (152) and is mounted rotatably on the post (143) on the mounting bracket (14). The neck (154) extends from the top of the curved flange and extends through the cutout (144) of the mounting bracket (14). The thumb tab (155) is formed on the neck (154) and protrudes out of the cavity (12) so the latch block (15) can be pivotally rotated.

The torsion spring (16) is mounted around the pivotal sleeve (151) and has two ends (164) attached respectively to the mounting bracket (14) and the latch block (15) to provide a restitution force on the latch block (15).

The wrist strap attachment (20) detachably engages the latch block (15) in the body (10) and has a strap clamp (202) and an elongated latch tab (21). The strap clamp (202) is securely attached to a wrist strap (23). The latch -tab (21) has an inner surface, an outer surface and a toothed face (22). The toothed face (22) is formed on the inner face of the elongated latch tab (21) and corresponds to the eccentrically curved toothed pawl face (153) on the latch block (15). The elongated latch tab (21) is inserted into the body (10) via the channel (13) and extends into the cavity (12). In the cavity (12), the toothed face (22) on the elongated latch tab (21) engages the eccentrically curved toothed pawl face (153) on the latch block (15). The wrist strap attachment (20) is pulled down, the latch block (15) pivots and tightly wedges and securely holds the elongated latch tab (21) between the latch block (15) and the lower side of the cavity (12) with the arrangement of the eccentrically curved toothed pawl face (153). Since the restitution force of the torsion spring (16) does not hold the wrist strap attachment (20) in the body (10), elastic fatigue of the torsion spring (16) will not allow the wrist strap attachment (20) to inadvertently disengage from the body (10).

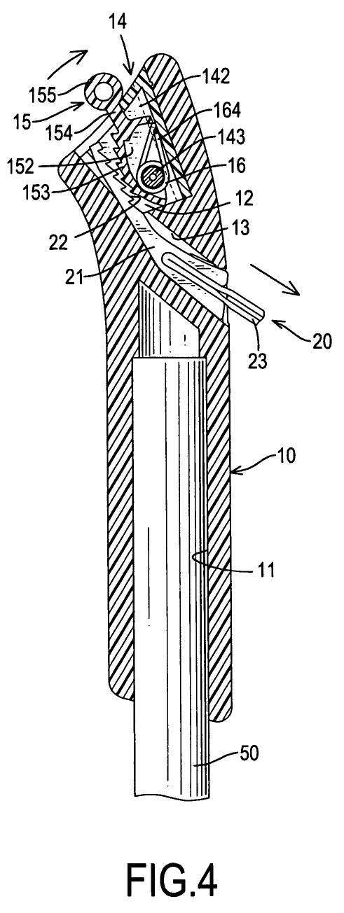

With further reference to FIG. 4, the wrist strap attachment (20) is separated from the body (10) by pushing the thumb tab (155) toward the upper side of the cavity (12) until the eccentrically curved toothed pawl face (153) completely disengages from the toothed face (22) on the elongated latch tab (21). Then, the wrist strap attachment (20) can be withdrawn from the body (10) conveniently.

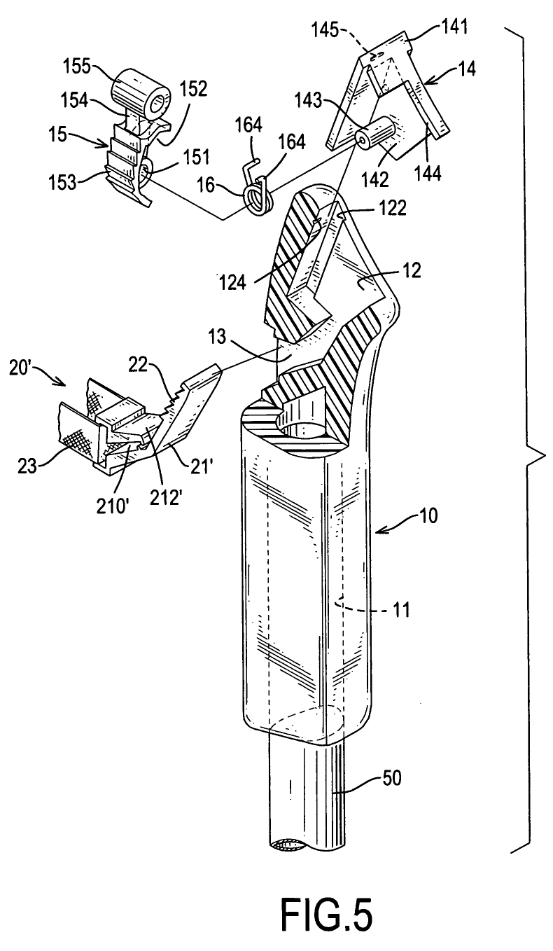

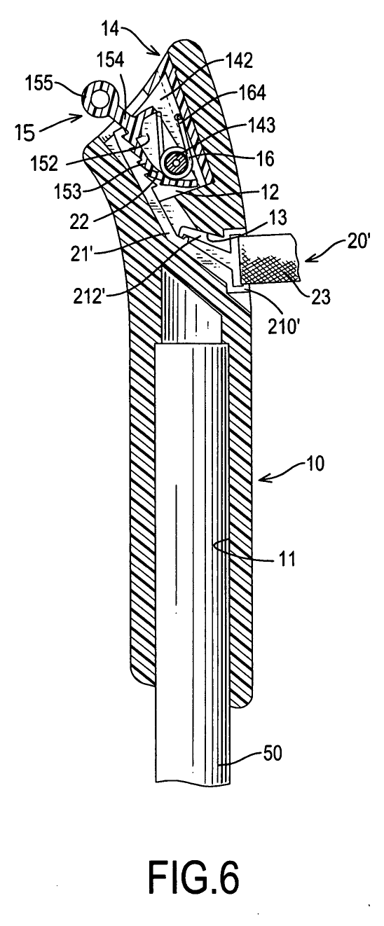

With reference to FIGS. 5 and 6, another preferred embodiment of the handle with a detachable wrist strap attachment in accordance with the present invention has the same structure as the previously described embodiment except for strip clamp on the wrist strap attachment (20′). The wrist strap attachment (20′) further has a clasp (210′) with a movable end (212′) formed on the elongated latch tab (21′). By moving the movable end (212′) to open the clasp (210′), the strap (23) can be detached from the elongated latch tab (21′) to conveniently remove any debris.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A handle with a detachable wrist strap attachment, the handle comprising:
a body (10) being an elongated solid and having
a top end;
a bottom end;
a side surface;
a cavity (12) defined at the top end; and
a channel (13) defined from the side surface to extend upwardly to communicate with the cavity (12);
a latch block (15) pivotally received inside the cavity (12) and having
an eccentrically curved toothed pawl face (153); and
a thumb tab (155) connecting to the eccentrically curved toothed pawl face (153) and protruding out of the cavity (12); and
a wrist strap attachment (20) detachably mounted in the channel (13) of the body (10) and engaging with the latch block (15), extending into the cavity (12) in the body and having
a strap (23);
an elongated latch tab (21) connected to the strap (23), detachably held in the channel (13) and having
an inner surface;
an outer surface; and
a toothed face (22) formed on the inner face and extending into the cavity (12) to detachably engage the eccentrically curved toothed pawl face (153) on the latch block (15).

2. The handle as claimed in claim 1, wherein
the body (10) further has
an inclined top face formed at the top end of the body (10); and
a shaft recess (11) longitudinally defined at the bottom end of the body (10);
the cavity (12) is defined at the inclined top face, is rectangular and has an open top, a upper side, a lower side, two sidewalls and a bottom; and
the latch block (15) has
a sidewall being oval and having a curved edge;
an eccentrically curved flange partially formed on and protruding from the curved edge and having
a top; and
an outer face, wherein the eccentrically curved toothed pawl face (153) is formed on the outer face of the curved flange;
an inner space (152) formed between the sidewall and the eccentrically curved flange;
a neck (154) extending from the top of the curved flange; and
a thumb tab (152) formed on the neck (154).

3. The handle as claimed in claim 2, wherein the latch block (15) further has a pivot sleeve (151) formed on the sidewall inside the inner space (152);
the handle further has:
a mounting bracket (14) mounted inside the cavity (12) of the body (10) having
a rear wall having two flanges (141) oppositely extending outward;
a top cover having a cutout (144);
a sidewall (142) mounted between the rear wall and the top cover; and
a post (142) formed on the sidewall to be rotatably mounted in the pivot sleeve (151) on the latch block (15); and
a torsion spring (16) mounted around the pivot sleeve (151) and having two ends (164) respectively attached to the mounting bracket (14) and the latch block (15);
wherein, the body (10) further has two grooves (122) respectively defined on the two sides near the upper side of the cavity (12) to respectively engage the two flanges (141) on the mounting bracket (14).

4. The handle as claimed in claim 3, wherein
a detent (124) is defined on the upper side of the cavity (12); and
a stub (145) is formed on the rear wall of the mounting bracket (14) to engage the detent (124) inside the cavity (12).

5. The handle as claimed in claim 1, wherein the wrist strap attachment (20′) further comprises has a clasp (210′) with a movable end (212′) formed on the elongated latch tab (21′).

6. The handle as claimed in claim 4, wherein the wrist strap attachment (20′) further comprises has a clasp (210′) with a movable end (212′) formed on the elongated latch tab (21′).
